(19) United States
(12) Patent Application Publication
(10) Pub. No.: US 2014/0150287 A1
(43) Pub. Date: Jun. 5, 2014

(54) METHOD OF DRYING MATERIAL BY MEMBRANE DEHUMIDIFIED AIR

(71) Applicants: Dongchan Ahn, Midland, MI (US); James S. Hrabal, St. Louis, MI (US); Aaron J. Greiner, Midland, MI (US)

(72) Inventors: Dongchan Ahn, Midland, MI (US); James S. Hrabal, St. Louis, MI (US); Aaron J. Greiner, Midland, MI (US)

(73) Assignee: Dow Corning Corporation, Midland, MI (US)

(21) Appl. No.: 14/131,565

(22) PCT Filed: Jul. 13, 2012
(86) PCT No.: PCT/US12/46660

§ 371 Date: Jan. 8, 2014

Related U.S. Application Data
(60) Provisional application No. 61/507,731, filed on Jul. 14, 2011.

(51) Int. Cl. F26B 21/08

(52) U.S. Cl. CPC F26B 21/08
USPC 34/474

(57) ABSTRACT

Various embodiments of the present invention relate to a method of drying a feed gas mixture. The method includes contacting a first side of one or more membranes with a feed gas mixture. The feed gas mixture includes at least water and a second gas component. Contacting the first side of the one or more membranes with the feed gas mixture produces a permeate gas mixture on a second side of the one or more membranes and a retentate gas mixture on the first side of the one or more membranes. The permeate gas mixture is enriched in water, and the retentate mixture is depleted in water. The one or more membranes have a H2O vapor permeability coefficient of at least about 25,000 Barrer at room temperature. Various embodiments of the present invention relate to a method of drying a material. The method includes contacting a material with the retentate gas mixture, to provide a dried material. Various embodiments also relate to membranes useful for performing the drying method, devices or machines that can perform the drying method, and materials dried by the drying method.

### CLAIM OF PRIORITY

This application claims the benefit of priority of U.S. Application Ser. No. 61/507,731, filed Jul. 14, 2011, entitled “METHOD OF DRYING MATERIAL BY MEMBRANE DEHUMIDIFIED AIR,” which application is herein incorporated by reference in its entirety.

Water needs to be removed on a large scale from many varied materials, including gases, solids, and liquids, as part of many routine industrial operations. For example, in the chemical industry, a particular process step may require that the moisture content of certain gases be below a certain concentration. In another example, a building may require dehumidified air in order to keep its occupants comfortable. Corn and other grains, coffee and other foodstuffs, coal, tobacco, wood, lumber, chemicals, sand, plaster, wastewater sludge, gas including air, and paint are all examples of non-gaseous materials from which water is removed or reduced in concentration on a large scale. However, current methods of drying gases, liquids, and solids can be expensive, time-consuming, inefficient, and inconvenient.

For example, the United States corn crop in 2010 was estimated to be 13.4 billion bushels grown on 80 million acres of land. Most corn and other crops are dried using heated air from gas heaters. Estimating the fuel requirement of the heaters to be approximately $26-$41 fuel per acre of corn dried, which means that the total 80 million acres of corn requires approximately $2-$4 billion in drying fuel costs.

### SUMMARY OF THE INVENTION

Various embodiments of the present invention relate to a method of drying a feed gas mixture. The method includes contacting a first side of one or more membranes with a feed gas mixture. The feed gas mixture includes at least water and a second gas component. Contacting the first side of the one or more membranes with the feed gas mixture produces a permeate gas mixture on a second side of the one or more membranes and a retentate gas mixture on the first side of the one or more membranes. The permeate gas mixture is enriched in water, and the retentate mixture is depleted in water. The one or more membranes have a H₂O vapor permeability coefficient of at least about 25,000 Barrer at room temperature. Various embodiments of the present invention relate to a method of drying a material. The method includes contacting a material with the retentate gas mixture, to provide a dried material. Various embodiments also relate to membranes useful for performing the drying method, devices or machines that can perform the drying method, and materials dried by the drying method.

Various embodiments provide certain advantages over other drying methods, some of which are surprising and unexpected. For example, the method of the present invention can remove water from gases more efficiently than other processes, including using less energy, using less time, or costing less money. In some embodiments, dried air provided by the gas-drying method can be used to dry materials more efficiently than other methods, including using less energy, using less time, or costing less money. In some examples, the ability to dry materials without high temperatures or by using significantly reduced temperatures can reduce the likelihood of thermal or thermooxidative degradation of the products, reduce fuel consumption and CO₂ emissions, and the process can be operated with fewer safety concerns relative to conventional high temperature drying processes. For example, some embodiments of the present invention can provide dry crops, grains, or foodstuffs, including corn, at a lower cost than current methods. In some examples, the ability to reduce time of drying can also significantly reduce the probability of mold or mildew formation and other forms of spoilage of the dried material, especially in the case of crops, grains, and the like.

The present invention provides a method of drying a feed gas mixture. The method includes contacting a first side of one or more membranes with a feed gas mixture. The feed gas mixture includes at least water and a second gas component. Contacting the first side of the one or more membranes with the feed gas mixture produces a permeate gas mixture on a second side of the one or more membranes and a retentate gas mixture on the first side of the one or more membranes. The permeate gas mixture is enriched in water. The retentate gas mixture is depleted in water. The one or more membranes have an H₂O vapor permeability coefficient of at least about 25,000 Barrer at room temperature.

The present invention provides a method of drying corn, grain, or foodstuffs. The method includes contacting a first side of one or more membranes with a feed gas mixture. The feed gas mixture includes at least water and air. The contacting of the first side of the one or more membranes with the feed gas mixture produces a permeate gas mixture on a second side of the one or more membranes and a retentate gas mixture on the first side of the one or more membranes. The permeate gas mixture is enriched in water. The retentate gas mixture is depleted in water. The one or more membranes have an H₂O vapor permeability coefficient of at least 25,000 Barrer at room temperature. The one or more membranes have a total surface area of at least 300 m². The method also includes contacting corn, grain, or foodstuffs with the retentate gas mixture, to provide a dried corn, dried grain, or dried foodstuffs.

### DETAILED DESCRIPTION OF THE INVENTION

Reference will now be made in detail to certain claims of the disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

References in the specification to “one embodiment,” “an embodiment,” “an example embodiment,” and the like, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to effect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

In this document, the terms “a,” “an,” or “the” are used to include one or more than one unless the context clearly dictates otherwise. The term “or” is used to refer to a nonexclusive “or” unless otherwise indicated. In addition it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range. When a range or a list of sequential values is given, unless otherwise specified any value within the range or any value between the given sequential values is also disclosed.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. Examples include acyl, cycloalkyl, aryl, aralkyl, heterocyclyl, heteroaryl, or heteroarylalkyl, linear and/or branched groups such as alkyl groups, fully or partially halogen-substituted haloalkyl groups, alkenyl groups, alkynyl groups, acrylate and methacrylate functional groups; and other organic functional groups such as ether groups, cyanate ester groups, ester groups, carboxylate salt groups, and masked isocyano groups.

The term “substituted” as used herein refers to an organic group as defined herein or molecule in which one or more bonds to a hydrogen atom contained therein are replaced by one or more bonds to a non-hydrogen atom. The term “functional group” or “substituent” as used herein refers to a group that can be or is substituted onto a molecule, or onto an organic group. Examples of substituents or functional groups include, but are not limited to, any organic group, a halogen (e.g., F, Cl, Br, and I); a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups.

The term “alkyl” as used herein refers to straight chain and branched alkyl groups and cycloalkyl groups having from 1 to about 20 carbon atoms, and typically from 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, isobutyl, sec-butyl, t-butyl, neopentyl, isopentyl, and 2,2-dimethylpropyl groups. As used herein, the term “alkyl” encompasses all branched chain forms of alkyl. Representative substituted alkyl groups can be substituted one or more times with any functional group, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to about 20 carbon atoms, and typically from 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)=CH(CH₃), —C(CH₂CH₃)═CH₂, cyclohexenyl, cyclopentenyl, cyclohexadienyl, butadienyl, pentadienyl, and hexadienyl, among others.

The term “resin” as used herein refers to polysiloxane material of any viscosity that includes at least one siloxane monomer that is bonded via a Si—O—Si bond to three or four other siloxane monomers. In one example, the polysiloxane material includes T or Q groups, as defined herein.

The term “oligomer” as used herein refers to a molecule having an intermediate relative molecular mass, the structure of which essentially includes a small plurality of units derived, actually or conceptually, from molecules of lower relative molecular mass. A molecule having an intermediate relative mass can be a molecule that has properties that vary with the removal of one or a few of the units. The variation in the properties that results from the removal of the one of more units can be a significant variation.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “light” as used herein refers to electromagnetic radiation in and near wavelengths visible by the human eye, and includes ultra-violet (UV) light and infrared light, from about 10 nm to about 300,000 nm wavelength.

The term “UV light” as used herein refers to ultraviolet light, which is electromagnetic radiation with a wavelength of about 10 nm to about 400 nm.

The term “infrared light” as used herein refers to electromagnetic radiation with a wavelength between about 0.7 micrometers and about 300 micrometers.

The term “cure” as used herein refers to exposing to radiation in any form, heating, or allowing to undergo a physical or chemical reaction that results in hardening or an increase in viscosity.

The term “pore” as used herein refers to a depression, slit, or hole of any size or shape in a solid object. A pore can run all the way through an object or partially through the object. A pore can intersect other pores.

The term “free-standing” or “unsupported” as used herein refers to a membrane with the majority of the surface area on each of the two major sides of the membrane not contacting a substrate, whether the substrate is porous or not. In some embodiments, a membrane that is “free-standing” or “unsupported” can be 100% not supported on both major sides. A membrane that is “free-standing” or “unsupported” can be supported at the edges or at the minority (e.g. less than about 50%) of the surface area on either or both major sides of the membrane.

The term “supported” as used herein refers to a membrane with the majority of the surface area on at least one of the two major sides contacting a substrate, whether the substrate is porous or not. In some embodiments, a membrane that is “supported” can be 100% supported on at least one side. A membrane that is “supported” can be supported at any suitable location at the majority (e.g. more than about 50%) of the surface area on either or both major sides of the membrane.

The term “enrich” as used herein refers to increasing in quantity or concentration, such as of a liquid, gas, or solute. For example, a mixture of gases A and B can be enriched in gas A if the concentration or quantity of gas A is increased, for example by selective permeation of gas A through a membrane to add gas A to the mixture, or for example by selective permeation of gas B through a membrane to take gas B away from the mixture.

The term “deplete” as used herein refers to decreasing in quantity or concentration, such as of a liquid, gas, or solute. For example, a mixture of gases A and B can be depleted in gas A if the concentration or quantity of gas A is decreased, for example by selective permeation of gas B through a membrane to take gas B away from the mixture, or for example by selective permeation of gas A through a membrane to add gas A to the mixture.

The term “solvent” as used herein refers to a liquid that can dissolve a solid, liquid, or gas. Nonlimiting examples of solvents are silicones, organic compounds, water, alcohols, ionic liquids, and supercritical fluids.

The term “selectivity” or “ideal selectivity” as used herein refers to the ratio of permeability of the faster permeating gas over the slower permeating gas, measured at room temperature.

The term “permeability” as used herein refers to the permeability coefficient (P_{X}) of substance X through a membrane, where q_{mX}=P_{X}*A* Δp_{X}*(1/delta), where q_{mX} is the volumetric flow rate of substance X through the membrane, A is the surface area of one major side of the membrane through which substance X flews (e.g. a non-edge surface of the membrane), Δpₓ is the pressure difference of the partial pressure of substance X across the membrane, and delta is the thickness of the membrane.

The term “Barrer” or “Barrers” as used herein refers to a unit of permeability, wherein 1 Barrer=10⁻¹¹ (cm³ gas) cm cm⁻² s⁻¹ mmHg⁻¹, or 10⁻¹⁰ (cm³ gas cm cm⁻² s⁻¹ cm Hg⁻¹, where “cm³ gas” represents the quantity of the gas that would take up one cubic centimeter at standard temperature and pressure.

The term “crops” as used herein refers to any plant or material derived from a plant, including, for example, corn, wheat, soy, barley, oat, coffee beans, tobacco, or the like.

The term “grains” as used herein refers to any seed material derived from a crop.

The term “foodstuffs” or “food” as used herein refers to any product that can be consumed by a human or animal, or that includes a product that can be consumed by a human or animal, including grains.

The term “air” as used herein refers to ambient air.

The term “dry” as used herein refers to the act or removing water or moisture from something, or to something that has had at least part of the water (e.g. moisture) removed from it.

The term “drier” as used herein refers to having less water.

The term “total surface area” as used herein with respect to membranes refers to the total surface area of the side of the membrane exposed to the feed gas mixture.

The term “air” as used herein refers to a mixture of gases with a composition approximately identical to the native composition of gases taken from the atmosphere, generally at ground level. In some examples, air is taken from the ambient surroundings. Air has a composition that includes approximately 78% nitrogen, 21% oxygen, 1% argon, and 0.04% carbon dioxide, as well as small amounts of other gases.

The term “room temperature” as used herein refers to ambient temperature, which can be, for example, between about 15° C. and about 28° C.

The term “water” as used herein can refer to any phase of water, including liquid or vapor, unless otherwise indicated.

Various embodiments of the present invention relate to a method of drying a feed gas mixture. The method includes contacting a first side of one or more membranes with a feed gas mixture. The feed gas mixture includes at least water and a second gas component. Contacting the first side of the one or more membranes with the feed gas mixture produces a permeate gas mixture on a second side of the one or more membranes and a retentate gas mixture on the first side of the one or more membranes. The permeate gas mixture is enriched in water, and the retentate mixture is depleted in water. The one or more membranes have a H₂O vapor permeability coefficient of at least about 25,000 Barrer at room temperature. Various embodiments of the present invention relate to a method of drying a material. The method includes contacting a material with the retentate gas mixture, to provide a dried material. Various embodiments also relate to membranes useful for performing the drying method, devices or machines that can perform the drying method, and materials dried by the drying method.

### Method of Drying a Feed Gas Mixture

In various embodiments, the present invention provides a method of drying a feed gas mixture. The method can include contacting a first side of one or more membranes with a feed gas mixture. The feed gas mixture can include at least water and a second gas component. Contacting the first side of the one or more membranes with the feed gas mixture can produce a permeate gas mixture on a second side of the one or more membranes and a retentate gas mixture on the first side of the one or more membranes. The permeate gas mixture can be enriched in water. The retentate gas mixture can be depleted in water. The one or more membranes can have an H₂O vapor permeability coefficient of at least about 25,000 Barrer at room temperature.

The feed gas mixture can be any suitable feed gas mixture that at least includes water and a gas. For example, the feed gas mixture can include oxygen, helium, hydrogen, carbon dioxide, nitrogen, ammonia, methane, hydrogen sulfide, argon, air, or any combination thereof. The feed gas can include any suitable gas known to one of skill in the art. The one or more membranes can be selectively permeable to any one gas in the feed gas, or to any of several gases in the feed gas. The one or more membranes can be selectively permeable to ail but any one gas in the feed gas. The one or more membranes can be selectively permeable to water vapor. The feed gas mixture can be drawn from any suitable source. For example, the feed gas mixture can be drawn from a supply tank. In another example, when the feed gas mixture includes air, the feed gas mixture can be drawn from the ambient air. Due to air being a common medium for which there is a need for drying, and due to dry air being a convenient dry gas that can be used for the drying of other materials, embodiments of the present invention can be particularly useful when the feed gas includes air. However, it is to be understood that embodiments of the present invention extend to feed gas mixtures that include water and any gas.

The feed gas mixture can be contacted to the one or more membranes. The feed gas mixture can be contacted to the one or more membranes in any suitable fashion. Preferably, the feed gas mixture is allowed to contact the one or more membranes at a pressure such that there is a positive gradient in water partial pressure across the membrane to drive the permeation of water vapor into the permeate side of the membrane. In one example, the feed gas mixture is allowed to contact the one or more membranes at ambient pressure. In another example, the feed gas mixture is allowed to contact the one or more membranes such that a pressure difference between the first and second sides of the one or more membranes occurs. The pressure difference can be such that the pressure of the feed gas mixture (on the first side of the one or more membranes) is greater than the pressure at the second side of the one or more membranes. In one example, the pressure difference is caused by the pressure of the feed gas mixture being at above ambient pressure; in such examples, the pressure of the feed gas mixture can be raised above ambient pressure using a compressor. In another example, the pressure difference is caused by the pressure at the second side of the one or more membranes being at below ambient pressure; in such examples, the pressure of the feed gas mixture can be reduced below ambient pressure using any suitable device. In other examples, a combination of lower than ambient pressure at the second side of the one or more membranes, and higher than ambient pressure at the first side of the one or more membranes, contributes to the pressure difference across the one or more membranes. In some embodiments, a higher-than-ambient pressure on the first side of the one or more membranes can be achieved by pumping feed gas to the first side of the one or more membranes and restricting the exit pathway of the retentate gas mixture from the one or more membranes. In some examples, if the water concentration in the gas at the second side of the one or more membranes is allowed to reach certain levels, the rate of separation of water from the feed gas mixture can be decreased. In some embodiments, a gas stream can be made to flow past the second side of the one or more membranes, to reduce the partial pressure of water vapor on the second side and help the permeate gas mixture including the separated water dissipate or be removed. Such a gas stream can be referred to as a sweep gas. Preventing the water concentration in the gas mixture on the second side of the one or more membranes from building up can enhance or maintain the efficiency of the separation.

In some examples, the permeate gas mixture is enriched in water relative to the feed gas mixture. For example, the permeate gas mixture can have a higher concentration of water than the feed gas mixture. In some examples, the retentate gas mixture is depleted in water relative to the feed gas mixture. For example, the retentate gas mixture can have a lower concentration of water than the feed gas mixture. In some embodiments, due for example to pressure or temperature variations between the feed gas mixture and the retentate or the permeate, the relative humidity of the feed gas mixture and the retentate and/or the permeate can be the about the same or similar, even though the retentate has less water concentration relative to the feed gas mixture, and even though the permeate has more water concentration relative to the feed gas mixture; in such situations, due to the similarity of the relative humidity of the retentate and feed gas mixtures, the drying ability of the retentate gas mixture can be the same or similar to that of the feed gas mixture. In some embodiments, however, the relative humidity of the retentate gas mixture is lower than that of the feed gas mixture, allowing the retentate gas mixture to have a greater drying ability than that of the feed gas mixture. One of skill in the art will readily appreciate that embodiments wherein the retentate gas mixture has a lower relative humidity than the feed gas mixture are especially preferred in embodiments wherein the retentate gas mixture is later used to dry a material.

In some embodiments, the method can include pressurizing the feed stream with a compressor, blower, or fan. The compressor, blower, or fan can be any suitable compressor, blower, or fan. The pressurization of the feed stream can help to maintain a desired pressure differential across the one or more membranes. In some embodiments, the method can include treating the feed stream with at least one pre-filter to remove particulates. The treatment of the feed stream with at least one pre-filter can occur before or after compression of the feed stream, if the feed stream is compressed. The filter can be any suitable filter that removes particulates from the feed stream. In some examples, the method can include optionally purging the permeate stream with a sweep gas. In some embodiments, a sweep gas purge of the permeate stream is used. In some embodiments, a sweep gas purge of the permeate stream is not used. The sweep gas can be any suitable sweep gas. The sweep gas may be externally provided, or provided by recycling some portion of the retentate stream to the permeate side of the membrane. The sweep gas may be fed in any flow configuration. Various suitable flow patterns can benefit the separation performance of the membrane. For example, in some embodiments, it is beneficial to supply the sweep gas in a manner to provide a counter-current flow pattern to the feed. The purging can help to lessen the concentration of water immediately adjacent the membrane, which can help to speed up the movement of water across the membrane. The sweep gas can be fed to the permeate side of the membrane at any suitable rate, such that the moist air is at least partially cleared from adjacent the membrane.

The one or more membranes can be free-standing or supported by a porous substrate. In some embodiments, the pressure on either side of the one or more membranes can be about the same. In other embodiments, there can be a pressure differential between one side of the one or more membranes and the other side of the one or more membranes. For example, the pressure on the feed and retentate side of the one or more membranes can be higher than the pressure on the permeate side of the one or more membranes. In other examples, the pressure on the permeate side of the one or more membranes can be higher than the pressure on the retentate side of the one or more membranes.

Any number of membranes can be used to accomplish the separation. For example, one membrane can be used. In other examples, about two, three, four, five, six, seven, eight, nine, ten, 100, 1000, 2000, 5000, 10,000, 100,000, about 1,000,000, or any suitable number of membranes can be used. The membranes can be used in series, in parallel, or in any combination thereof. The one or more membranes need not all include the same reaction product. In some embodiments, all the membranes include the same reaction product. The membranes can have different properties, and can have different permeability for a particular gas. In other embodiments, the membranes have the same properties. Any combination of free-standing and supported membranes can be used. Any suitable surface area of the one or more membranes can be used. For example, the surface area of each membrane, or the total surface area of the membranes, can be about 0.01 m², 0.1, 1, 2, 3, 4, 5, 10, 100, 200, 300, 400, 500, 600, 700, 800, 900, 1000, 1200, 1400, 1600, 1800, 2000, 2200, 2400, 2600, 2800, 3000, 3200, 3400, 3800, 4000, 5000, 10,000, 50,000, 100,000, 500,000, or about 1,000,000 m².

The one or more membranes can be manufactured as flat sheets or as fibers and can be packaged into any suitable variety of modules including hollow fibers, sheets or arrays of hollow fibers or sheets. Common module forms include hollow fiber modules, spiral wound modules, plate-and-frame modules, tubular modules and capillary fiber modules. The sheets, fibers or leaflets may be of any size or aspect ratio and can assume any packing density in the module. Methods of making hollow fibers modules and spiral wound modules are known in the art, such as described in Baker, R. W. Membrane Technology and Applications, 2nd Edition; 2nd ed.; John Whey & Sons Inc.: West Sussex, England, 2004, and in U.S. Pat. Nos. 3,339,341 and 4,871,379 (Maxwell et al., Edwards et al.) and U.S. Pat. No. 5,034,126 (Reddy et al.). Various methods and configurations for delivering the feed gas mixture and recovering the permeate and retentate mixtures are also known in the art. In some cases, a single membrane module can be used. In other examples, multiple modules can be used in a variety of arrangements, including serial or parallel arrays of modules, or any combination of single and multiple modules in any arrangement.

In one example, the one of more membranes is one or more hollow tube or fiber membranes. Any number of hollow tube or fiber membranes can be used. For example, 1 hollow tube or fiber membrane, 2, 3, 4, 5, 10, 20, 50, 100, 500, 1000, 2000, 5000, 10,000, 100,000 or about 1,000,000 hollow tube or fiber membranes can be used together as the one or more membranes. The one or more hollow tube or fiber membranes can be in the form of a modular cartridge, such that the one or more membranes can be easily replaced or maintained. In one embodiment, the inside of the one or more hollow tube or fiber membranes can be the first side of the one or more membranes, and the outside of the one or more hollow tube or fiber membranes can be the second side of the one or more membranes. In another embodiment, the outside of the one or more hollow tube or fiber membranes can be the first side of the one or more membranes, and the inside of the one or more hollow tube or fiber membranes can be the second side of the one or more membranes. In some examples, a pressure difference is maintained between the first and second side of the one or more hollow tube or fiber membranes.

One versed in the art of membrane separations can identify operating conditions for a given combination of membrane performance properties such as selectivity and flux to achieve a desired level of separation optimized on the basis of capital and operating costs, plant footprint, environmental conditions, and maintenance and reliability. Alternately, one can use the desired separation and economic conditions to guide the development of materials with the desired separation properties. The membrane system can be operated in conjunction with compressors, vacuum systems, pre-filters, heaters, chillers, condensers, or any other type of operation either upstream or downstream of the membrane system. The permeate side of the one or more membranes can be operated under a positive pressure, ambient pressure, or negative pressure (e.g. vacuum) with or without a sweep gas or a sweep liquid such as found in a membrane contactor (e.g. a device that permits mass transfer between a gaseous phase and a liquid phase across a membrane without dispersing the phases in one another). The sweep gas can be any gas, and can originate from outside the process or be recycled from within the process, or include a mixture thereof. For example, hollow fiber modules can be fed from the bore side or from the shell side, at any position of entry. The feed gas inlets and permeate gas outlets can be positioned to permit a counter-current, cross-current or co-current flow configuration.

The modules can be operated as single membrane modules or organized further into arrays or banks of modules. The individual membrane modules or arrays or banks of modules can further be configured into additional staged superstructures, such as in series, parallel or cascade configurations, to allow enhanced flux or separation. Partial recycling of the permeate or retentate can also be used to achieve a more efficient separation, For example, if the residue stream requires further purification, it may be passed to a second bank of membrane modules for further separation. Likewise, if the permeate stream requires further concentration, it may be passed to a second bank of membrane modules for a second-stage separation. Such multi-stage or multi-step processes, and variants thereof, will be familiar to those of skill in the art, who will appreciate that the membrane separation step may be configured in many possible ways, including single-stage, multistage, multistep, or more complicated arrays of two or more units in serial or cascade arrangements.

### Method of Drying a Material

Various embodiments of the present invention provide a method of drying a material. The method can include contacting the retentate gas mixture to a material, to provide a dried material. In some embodiments, the dried material can have any concentration of water that is less than the concentration of water within the material prior to the contacting with the retentate gas mixture. In some examples, the dried material can have about 1% less, 2%, 3%, 4%, 5%, 10%, 20%, 40%, 60%, 80%, 90%, 95%, 96%, 97%, 98%, or about 99% less concentration of water than was present prior to the contacting of the material with the retentate gas mixture.

In some examples, the contacting can be direct, such that the retentate gas mixture directly contacts the material, to provide a dried material.

For example, a grain, foodstuff, or crop can be directly contacted with the retentate gas mixture, providing a dried foodstuff, dried crop, or dried grain. In other examples, the contacting can be indirect, such that the retentate gas mixture does not directly contact the material, to provide a dried material In one example, a grain, foodstuff, or crop is within a container, and retentate gas mixture is allowed to flow into the top or bottom of the container. As the retentate gas mixture enters the container, it contacts other gas already present within the container. As the retentate gas diffuses throughout the container, the water concentration of the gas already present within the container is decreased due to the combination with retentate gas mixture, allowing the material within the container to become dried. However, since the retentate gas mixture has been mixed with the gas mixture already present within the container, one of skill in the art might characterize the gas that ultimately contacts the crop, grain, or foodstuff as different from the retentate gas mixture. Herein it is to be understood that such indirect contacting is considered to be contacting the material.

The material to be dried can be any suitable material. Some examples of materials that can be dried include crops, grains, foodstuffs, coal, particles, powders, tobacco, wood, lumber, chemicals, sand, plaster, wastewater sludge, paint, coatings, varnishes, inks, produce, meats, gas, textiles, clothing, furniture, or a combination thereof. Any suitable quantity of materials can be dried. The material to be dried can be contacted with the retentate mixed in any suitable fashion. For example, the material to be dried can be suspended in one or more of an inner, outer, lower, middle, or upper portions of a container, or a combination thereof, and the retentate gas mixture can he injected into the container from the top, middle, or bottom of the container, or a combination thereof, to provide a dried material. The container used can be any container. For example, the container can be a cylindrical or square shape, or the container can have any suitable shape. For example, the container could be a house, an apartment, a laboratory, a barn, a silo, any suitable container designed for traditional hot-air drying of crops, a storage bin, a shed, an environmental chamber, a chemical hood, or a microreactor of any size. The container can be sub-divided into any suitable number of compartments, which can be arranged in any suitable fashion and separated by any suitable type of porous or non-porous partition. In some examples, the compartments can be arranged in a concentric, staggered, or spiral fashion separated by a series of channels through which the retentate gas stream primarily flows. In some examples, the container may have a conically shaped bottom or top, or the container can have any appropriately shaped bottom or top. In some examples, the container can be a storage bin, such as an agricultural storage bin, with a perforated inner floor, wall, or ceiling that separates the crops, grains, or foodstuffs from an empty volume through which the dried gas or air can be supplied. For instance, the container can be a corn-drying bin with a perforated floor above the ground level to permit the dried air to be supplied through the unoccupied lower volume of the bin beneath the perforated floor by a blower then pass upward through the occupied volume to reduce the moisture content of the corn. In another example, the container can be a vertically or horizontally oriented corn, grain or foodstuffs drying apparatus in which the retentate stream from the membrane is optionally heated and fed into one or more channels (or plenum chambers) through which the heated air is normally fed to dry the corn, grain or foodstuffs. In some examples, the container comprises one or more mixers, conveyers or augers to mix or transport the corn, grain or foodstuffs into, out of, or within the container.

In some embodiments, the one or more membranes can form a membrane system, such as a bank of modules, in which the operating conditions are controlled by a feedback or feedforward control system to achieve a desired moisture content. For example, a moisture or relative humidity sensor and temperature gauge can be used to monitor the moisture content of the product or atmosphere to be dried and fed back though a process controller with suitable hardware to adjust the feed or permeate pressures or temperatures; feed, permeate or sweep gas flow rates; or membrane area to achieve the desired moisture content through a variety of known process control algorithms. Examples of such algorithms include but are not limited to proportional control, proportional-integral control, proportional-derivative, and proportional-integral-derivative control. The membrane system can be operated under any suitable combination of temperatures, pressures and flow rates. In some examples, the temperatures, pressures of various components and flow rates of various streams of the membrane system are operated under conditions to minimize or eliminate the condensation of water vapor. In some examples, the wet air (e.g. the feed) is fed into the inner (bore) surfaces of one more hollow fiber membranes, and the permeate stream and optional sweep gases are present on the outer surfaces (shell side) of the one or more hollow fiber membranes housed in one more canisters that can be drained continuously or intermittently to remove condensed water from the permeate stream.

### Membrane

In one embodiment, the present invention includes one or more membranes that include a reaction product of an organosilicon composition. The one or more membranes of the present invention can include any suitable polysiloxane. In another embodiment, the present invention provides a method of forming one or more membranes. The present invention can include the step of forming one or more membranes. The one or more membranes can be formed on at least one surface of a substrate. For any membrane to be considered “on” a substrate, the one or more membranes can be attached (e.g. adhered) to the substrate, or be otherwise in contact with the substrate without being adhered. The substrate can have any surface texture, and can be porous or non-porous. The substrate can include surfaces that are not coated with one or more membranes by the step of forming one or more membranes. All surfaces of the substrate can be coated by the step of forming one or more membranes, one surface can be coated, or any number of surfaces can be coated.

A step of forming a membrane can include two steps. In the first step, the composition that forms the membrane can be applied to at least one surface of the substrate. In the second step, the applied composition that forms the membrane can be cured to form the membrane. In some embodiments, the curing process of the composition can begin before, during, or after application of the composition to the surface. The curing process transforms the composition that forms the membrane into the membrane. The composition that forms the membrane can be in a liquid state. The membrane can be in a solid state.

The composition that forms the membrane can be applied using conventional coating techniques, for example, immersion coating, spin coating, dipping, spraying, brushing, roll coating, extrusion, screen-printing, pad printing, or inkjet printing.

Curing the composition that forms the membrane can include the addition of a curing agent or initiator such as, for example, a hydrosilylation catalyst. In some embodiments, the curing process can begin immediately upon addition of the curing agent or initiator. The addition of the curing agent or initiator may not begin the curing process immediately, and can require additional curing steps. In other embodiments, the addition of the curing agent or initiator can begin the curing process immediately, and can also require additional curing steps. The addition of the curing agent or initiator can begin the curing process, but not bring it to a point where there composition is cured to the point of being fully cured, or of being unworkable. Thus, the curing agent or initiator can be added before or during the coating process, and further processing steps can complete the cure to form the membrane.

Curing the composition that forms the membrane can include a variety of methods, including, for example, the curing of the organosilicon composition can be hydrosilylation curing, condensation curing, free-radical curing, amine-epoxy curing, radiative curing, evaporative curing, cooling, or any combination thereof.

The one or more membranes of the present invention can have any suitable thickness. In some examples, the one or more membranes have a thickness of from about 1 μm to about 20 μm. In some examples, the one or more membranes have a thickness of from about 0.1 μm to about 200 μm. In other examples, the one or more membranes have a thickness of from about 0.01 μm to about 2000 μm.

The one or more membranes of the present invention can be selectively permeable to one substance over another. In one example, the one or more membranes is selectively permeable to one gas over other gases or liquids. In another example, the one or more membranes is selectively permeable to more than one gas over other gases or liquids. In one embodiment, the one or more membranes is selectively permeable to one liquid over other liquids or gases. In another embodiment, the one or more membranes is selectively permeable to more than one liquid over other liquids. In an embodiment, the one or more membranes are selectively permeable to water over other gases or liquids. In some examples, the one or more membranes have an H₂O vapor/N₂ ideal selectivity of at least about 50, at least about 90, at least about 100, at least about 120, at least about 130, at least about 150, at least about 200, or at least about 250 at room temperature. In some embodiments, with a the one or more membranes has an H₂O vapor permeability coefficient of at least about 10,000 Barrer, 15,000 Barrer, 20,000 Barrer, Barrer, 25,000 Barrer, 27,500 Barrer, 30,000 Barrer, 32,500 Barrer, 35,000 Barrer, 40,000 Barrer, 50,000 Barrer, 60,000 Barrer, or at least about 70,000 Barrer at room temperature.

The one or more membranes of the present invention can have any suitable shape. In some examples, the one or more membranes of the present invention are plate-and-frame membranes, spiral wound membranes, tubular membranes, capillary fiber membranes, or hollow fiber membranes. In some embodiments, the one or more membranes can be used in conjunction with a liquid that enhances gas transport, such as in a membrane contactor (e.g. a device that permits mass transfer between a gaseous phase and a liquid phase across a membrane without dispersing the phases in one another).

### Supported Membrane

In some embodiments of the present invention, the membrane is supported on a porous or highly permeable non-porous substrate. The substrate can be any suitable substrate. A supported membrane has the majority of the surface area of at least one of the two major sides of the membrane contacting a porous or highly permeable non-porous substrate. A supported membrane on a porous substrate can be referred to as a composite membrane, where the membrane is a composite of the membrane and the porous substrate. The porous substrate on which the supported membrane is located can allow gases to pass through the pores and to reach the membrane. The supported membrane can be attached (e.g. adhered) to the porous substrate. The supported membrane can be in contact with the substrate without being adhered. The porous substrate can be partially integrated, fully integrated, or not integrated into the membrane.

### Unsupported Membrane

In some embodiments of the present invention, the membrane is unsupported, also referred to as free-standing. The majority of the surface area on each of the two major sides of a membrane that is free-standing is not contacting a substrate, whether the substrate is porous or not. In some embodiments, a membrane that is free-standing can be 100% unsupported. A membrane that is free-standing can be supported at the edges or at the minority (e.g. less than 50%) of the surface area on either or both major sides of the membrane. The support for a free-standing membrane can be a porous substrate or a nonporous substrate. Examples of suitable supports for a free-standing membrane can include any examples of supports given in the above section Supported Membrane. A free-standing membrane can have any suitable shape, regardless of the percent of the free-standing membrane that is supported. Examples of suitable shapes for free-standing membranes include, for example, squares, rectangles, circles, tubes, cubes, spheres, cones, and planar sections thereof, with any thickness, including variable thicknesses.

In examples that include a substrate, the substrate can be porous or nonporous. The substrate can be any suitable material, and can be any suitable shape or size, including planar, curved, solid, hollow, or any combination thereof. Suitable materials for porous or nonporous substrates include any polymers described above as suitable for use as porous substrates in supported membranes. The substrate can be a water soluble polymer that is dissolved by purging with water. The substrate can be a fiber or hollow fiber, as described in U.S. Pat. No. 6,797,212 B2. In some examples, the substrate is coated with a material prior to formation of the membrane that facilitates the removal of the membrane once formed. The material that forms the substrate can be selected to minimize sticking between the membrane and the substrate. In some examples, the membrane can be heated, cooled, washed, etched or otherwise treated to facilitate removal from the substrate. In other examples, air pressure can be used to facilitate removal of the membrane from the substrate.

### Cured Product of an Orqanosilicon Composition

The one or more membranes of the present invention can include the cured product of an organosilicon composition. The organosilicon composition can be any suitable organosilicon composition. The curing of the organosilicon composition gives a cured product of the organosilicon composition. The curable silicone composition includes at least one suitable polysiloxane compound. The silicone composition includes suitable ingredients to allow the composition to be curable in any suitable fashion. In addition to the at least one suitable polysiloxane, the silicone composition can include any suitable additional ingredients, including any suitable organic or inorganic component, including components that do not include silicon, including components that do not include a polysiloxane structure. In some examples, the cured product of the silicone composition includes a polysiloxane.

The curable silicon composition can include molecular components that have properties that allow the composition to be cured. In some embodiments, the properties that allow the silicone composition to be cured are specific functional groups. In some embodiments, an individual compound contains functional groups or has properties that allow the silicone composition to be cured by one or more curing methods. In some embodiments, one compound can contain functional groups or have properties that allow the silicone composition to be cured in one fashion, while another compound can contain functional groups or have properties that allow the silicone composition to be cured in the same or a different fashion. The functional groups that allow for curing can be located at pendant or, if applicable, terminal positions in the compound.

The silicone composition can include an organic compound. The organic compound can be any suitable organic compound. The organic compound can be, for example, an organosilicon compound. The organosilicon compound can be any organosilicon compound. The organosilicon compound can be, for example, a silane, polysilane, siloxane, or a polysiloxane, such as any suitable one of such compound as known in the art. The silicone composition can contain any number of suitable organosilicon compounds, and any number of suitable organic compounds. An organosilicon compound can include any functional group that allows for curing.

In some embodiments, the organosilicon compound can include a silicon-bonded hydrogen atom, such as organohydrogensilane or an organohydrogensiloxane. In some embodiments, the organosilicon compound can include an alkenyl group, such as an organoalkenylsilane or an organoalkenyl siloxane. In other embodiments, the organosilicon compound can include any functional group that allows for curing. The organosilane can be a monosilane, disilane, trisilane, or polysilane. Similarly, the organosiloxane can be a disiloxane, trisiloxane, or polysiloxane. The structure of the organosilicon compound can be linear, branched, cyclic, or resinous. Cyclosllanes and cyclosiloxanes can have from 3 to 12 silicon atoms, alternatively from 3 to 10 silicon atoms, alternatively from 3 to 4 silicon atoms.

In one example, an organohydrogensilane can have the formula HR¹₂Si—R²—SiR¹₂H, wherein R¹ is C₁₋₁₀ hydrocarbyl or C₁₋₁₀ halogen-substituted hydrocarbyl, both free of aliphatic unsaturation, linear or branched, and R² is a hydrocarbylene group free of aliphatic unsaturation having a formula selected from monoaryl such as 1,4-disubstituted phenyl, 1,3-disubstituted phenyl; or bisaryl such as 4,4′-disubstituted-1,1′-biphenyl, 3,3′-disubstituted-1,1′-biphenyl, or similar bisaryl with a hydrocarbon chain including 1 to 6 methylene groups bridging one aryl group to another.

The organosilicon compound can be an organopolysiloxane compound. In some examples, the organopolysiloxane compound has an average of at least one, two, or more than two functional groups that allow for curing, The organopolysiloxane compound can have a linear, branched, cyclic, or resinous structure. The organopolysiloxane compound can be a homopolymer or a copolymer. The organopolysiloxane compound can be a disiloxane, trisiloxane, or polysiloxane.

In one example, an organopolysiloxane can include a compound of the formula

R¹₃SiO(R¹₂SiO)_{α}(R¹R²SiO)_{β}SiR¹₃, (a)

or

R⁴R³₂SiO(R³₂SiO)_{χ}(R³R⁴SiO)_{δ}SiR³₂R⁴.

In formula (a), α has an average value of about 0 to about 2000, and β has an average value of about 2 to about 2000. Each R¹ is independently a monovalent functional group. Suitable monovalent functional groups include, but are not limited to, acrylic groups; alkyl; halogenated hydrocarbon groups; alkenyl; alkynyl; aryl; and cyanoalkyl. Each R² is independently a functional group that allows for curing of the silicone composition, or R¹.

In formula (b), χ has an average value of 0 to 2000, and δ has an average value of 0 to 2000. Each R³ is independently a monovalent functional group. Suitable monovalent functional groups include, but are not limited to, acrylic groups; alkyl; halogenated hydrocarbon groups; alkenyl; alkynyl; aryl; and cyanoalkyl. Each R⁴ is independently a functional group that allows for curing of the silicone composition, or R³.

An organopolysiloxane compound can contain an average of about 0.1 Mole % to about 100 mole % of functional groups that allow for curing of the silicone composition, and any range of mole % therebetween. The mole percent of functional groups that allow for curing of the silicon composition in the resin is the ratio of the number of moles of siloxane units in the resin having a functional group that allows for curing of the silicone composition to the total number of moles of siloxane units in the organopolysilaxane, multiplied by 100.

The organopolysiloxane compound can be a single organopolysiloxane or a combination including two or more organopolysiloxanes that differ in at least one of the following properties: structure, viscosity, average molecular weight, siloxane units, and sequence.

Examples of organopolysiloxanes can include compounds having the average unit formula

(R¹R⁴R⁵SiO_{1/2)w}(R¹R⁴SiO_{2/2})ₓ(R⁴SiO_{3/2})_{y}(SiO_{4/2})_{z} (I),

wherein R¹ is a functional group independently selected from any optionally further substituted C₁₋₁₅ functional group, including C₁₋₁₅ monovalent aliphatic hydrocarbon groups, C₄₋₁₅ monovalent aromatic hydrocarbon groups, and monovalent epoxy-substituted functional groups, R⁴ is a functional group that allows for curing of the silicone composition or R⁵ or R¹, R⁵ is R¹ or R⁴, 0≦w<0.95, 0≦x<1, 0≦y<1, 0≦z<0.95, and w+x+y+z≈1.In some embodiments, R¹ is C₁₋₁₀ hydrocarbyl or C₁₋₁₀ halogen-substituted hydrocarbyl, both free of aliphatic unsaturation, or C₄ to C₁₄ aryl. In some embodiments, w is from 0.01 to 0.6, x is from 0 to 0.5, y is from 0 to 0.95, z is from 0 to 0.4, and w+x+y+z≈1.

In descriptions of average unit formula, such as formula I, the subscripts w, x, y, and z are mole fractions. It is appreciated that those of skill in the art understand that for the average unit formula (I), the variables R¹, R⁴, and R⁵ can independently vary between individual siloxane formula units. Alternatively, the variables R¹, R⁴, and R⁵ can independently be the same between individual siloxane formula units. For example, average unit formula (I) above can include the following average unit formula:

(R¹R⁴R⁵SiO_{1/2})_{w}(R^{1a}R⁴SiO_{2/2})ₓ₁(R^{1b}R⁴SiO_{2/2})ₓ₂(R⁴SiO_{3/2})_{y}(SiO_{4/2})_{z}

wherein subscripts x1+x2=x, and where R^{1a} is not equal to R^{1b}. Alternatively, R^{1a} can be equal to R^{1b}.

Curing

Embodiments of the membrane include a cured product of a silicone composition. Various methods of curing can be used, including any suitable method of curing, including for example hydrosilylation curing, condensation curing, free-radical curing, amine-epoxy curing, radiation curing, cooling, or any combination thereof. A composition that is cured via one curing method can be cured by other curing methods in addition to the one curing method. The silicone composition can include molecules with properties that allow one curing method, as well as molecules that allow different curing methods. In some embodiments, the silicone composition can include multiple features on the same molecule that allow the composition to be cured via one curing method and cured via other curing methods, and in some embodiments, the silicone composition can include features that allow it to be cured via one curing method on one molecule and features that allow it to be curing via other curing methods on a different molecule.

A silicone composition that is curable via a particular method can include other compounds curable via the particular method in addition to silicone compounds. In some embodiments, the other compounds curable via the particular curing method can participate with the silicone compounds curable via the particular curing method during the application of the particular curing method. In other embodiments, the other compounds curable via the particular curing method do not participate with the silicone compounds curable via the particular curing method during application of the particular curing method.

In hydrosilylation curing, for example, an organosilicon compound that includes a silicon atom with a silicon-bonded hydrogen atom reacts with an unsaturated group such as an alkenyl group, adding across the unsaturated group and causing the unsaturated group to lose at least one degree of unsaturation (e.g. a double bond is converted to a single bond), such that the silicon atom is bound to one carbon atom of the originally unsaturated group, and the hydrogen atom is bound to the other carbon atom of the originally unsaturated group. Having an average of at least two unsaturated groups on one or more molecules and an average of greater than two silicon-bonded hydrogen atoms on one or more molecules can help cross-linking to occur. In another example, having an average of greater than two unsaturated groups on one or more molecules and an average of at least two silicon-bonded hydrogen atoms on one or more molecules can help cross-linking to occur. In one example, a curable silicone composition that is hydrosilylation curable can include a compound having an average of at least two unsaturated groups per molecule; an organosilicon compound having an average of at least two silicon-bonded hydrogen atoms per molecule; and an optional hydrosilylation catalyst. In some embodiments, the hydrosilylation catalyst is present. In other embodiments, the hydrosilylation catalyst is not present. In some embodiments, the unsaturated groups are alkenyl groups.

In some embodiments, the hydrosilylation catalyst can be any hydrosilylation catalyst including a platinum group metal or a compound containing a platinum group metal. Platinum group metals can include platinum, rhodium, ruthenium, palladium, osmium and iridium.

Examples of hydrosilylation catalysts include the complexes of chloroplatinic acid and certain vinyl-containing organosiloxanes disclosed by Willing in U.S. Pat. No. 3,419,593, such as the reaction product of chloroplatinic acid and 1,3-divinyl-1,1,3,3-tetramethyldisiloxane; microencapsulated hydrosilylation catalysts including a platinum group metal encapsulated in a thermoplastic resin, as exemplified in U.S. Pat. No. 4,766,176 and U.S. Pat. No. 5,017,654; and photoactivated hydrosilylation catalysts, such as platinum(II) bis(2,4-pentanedioate), as exemplified in U.S. Pat. No. 7,799,842. An example of a suitable hydrosilylation catalyst can include a platinum(IV) complex of 1,3-diethenyl-1,1,3,3-tetramethyldisiloxane.

In another embodiment, the hydrosilylation catalyst can be at least one photoactivated hydrosilylation catalyst. The photoactivated hydrosilylation catalyst can be any of the well-known hydrosilylation catalysts including a platinum group metal or a compound containing a platinum group metal. The suitability of particular photoactivated hydrosilylation catalyst for use in a silicone composition of the present invention can be readily determined by routine experimentation.

The concentration of the hydrosilylation catalyst can be sufficient to catalyze hydrosilylation of the curable silicone composition, for example sufficient to catalyze the addition reaction (hydrosilylation) of an organosilicon compound having an average of at least two silicon-bonded hydrogen atoms per molecule with an organopolysiloxane having an average of at least two silicon-bonded alkenyl groups per molecule. Typically, the concentration of the hydrosilylation catalyst is sufficient to provide from about 0.1 to about 1000 ppm of a platinum group metal, from about 0.5 to about 500 ppm of a platinum group metal, and more preferably from about 1 to about 100 ppm of a platinum group metal, based on the total weight of the uncured composition. The rate of cure can be very slow below about 0.1 ppm of platinum group metal. The use of more than 1000 ppm of platinum group metal is possible, but is generally undesirable because of catalyst cost.

In condensation curing, for example, an organosilicon compound that includes a silicon-bonded hydrolysable group reacts with water to form a hydroxy-substituted silicon atom. The reactive hydroxy group can then attack other silicon atoms, including other silicon atoms with hydrolysable groups or with hydroxy groups, forming a polysiloxane. In some embodiments, the silicon atom that is attacked by the reactive hydroxy group can have a protonated hydroxy group or a hydrolysable group, wherein the protonated hydroxy group or the hydrolysable group is a good leaving group. In some embodiments, water is not required to hydrolyze a hydrolysable group, but rather a reactive hydroxy-substituted organosilicon is already present in the curable silicone composition, which can attack other silicon atoms, including silicon atoms with hydroxy groups or silicon atoms with hydrolysable groups. An acid or base catalyst is an optional component in condensation curable silicone compositions, such as any suitable organic or mineral acid, or any suitable base. In some embodiments, an acid or base catalyst is present. In other embodiments, an acid or base catalyst is not present.

A condensation curable silicone composition can include an organosilicon with at least one silicon-substituted hydrolysable group, or with at least one silicon-substituted hydroxy group. The organosilicon can be a silane, a polysilane, a siloxane, or a polysiloxane. The organosilicon can include an average of one silicon-substituted hydrolysable group per molecule, an average of two silicon-substituted hydrolysable groups per molecule, or more.

A hydrolysable group can be a group that reacts with water in the absence of a catalyst at any temperature from room temperature to 100° C. within several minutes, for example thirty minutes, to form a silanol (Si—OH) group, or another hydroxy-substituted group. Examples of hydrolysable groups can include, but are not limited to, —Cl, —Br, —OR⁷, —OCH₂CH₂OR⁷, CH₃C(═O)O—, Et(Me)C═N—O—, CH₃C(═O)N(CH₃)—, and —ONH₂, wherein R₇ is C₁ to C₈ hydrocarbyl or C₁ to C₈ halogen-substituted hydrocarbyl. In one example, a condensation curable silicone composition includes one or more of the following: Me₂ViSiCl, Me₃SiCl, MeSi(OEt)₃, PhSiCl₃, MeSiCl₃, Me₂SiCl₂, PhMeSiCl₂, SiCl₄, Ph₂SiCl₂, PhSi(OMe)₃, MeSi(OMe)₃, PhMeSi(OMe)₂, and Si(OEt)₄, wherein Me is methyl. Et is ethyl, and Ph is phenyl.

Optionally, a condensation curable composition can include a condensation catalyst. In some embodiments, a condensation catalyst is present. In other embodiments, a condensation catalyst is not present. Examples of condensation catalysts include, for example, amines, and complexes of lead, tin, zinc, titanium, zirconium, aluminum and iron with carboxylic acids. In one example, the condensation catalyst can be selected from tin(II) and tin(IV) compounds such as tin dilaurate, tin dioctoate, and tetrabutyl tin; and titanium compounds such as titanium tetrabutoxide.

In free-radical curing, for example, a free-radical is generated. The free-radical then can attack a free-radical polymerizable functional group. The attacking group forms a bond to the free-radical polymerizable group, and transfers a radical thereto. The free-radical polymerizable functional group can then go on to attack other free-radical polymerizable functional groups.

A free-radical curable silicone composition can include an organosilicon with at least one free-radical polymerizable group. The organosilicon can be a silane, a polysilane, a siloxane, or a polysiloxane. The organosilicon can include an average of one free-radical polymerizable group per molecule, an average of two free-radical polymerizable groups per molecule, or more. In some embodiments, a free-radical curable silicone composition can include an organic compound that does not include silicon that has at least one free-radical polymerizable group. The organic compound that does not include silicon can include an average of one free-radical polymerizable groups per molecule, an average of two free-radical polymerizable groups per molecule, or more. Examples of free-radical polymerizable groups include, for example, alkenyl groups and alkynyl groups, as well as groups such as ethers, ketones, aldehydes, carboxylates, ketals, acetals, cyano groups, nitro groups, or halogens.

Free-radicals can be generated by any suitable method. Free radicals can be initiated by, for example, thermal decomposition, photolysis, redox reactions, persulfates, ionizing radiation, electrolysis, plasma, sonication, or a combination thereof. In one example, a free-radical is generated using a free-radical initiator. A free-radical initiator is an optional ingredient. In some embodiments, a free-radical initiator is present. In other embodiments, a free-radical initiator is not present. In one example, the free-radical initiator can be a free-radical photoinitiator, an organic peroxide, or a free-radical initiator activated by heat. Further, a free-radical photoinitiator can be any free radical photoinitiator capable of initiating cure (cross-linking) of the free-radical polymerizable functional groups upon exposure to radiation, for example, having a wavelength of from 200 to 800 nm. In another example, the free-radical initiator is a organoborane free-radical inflator. In one example, the free-radical initiator can be an organic peroxide. For example, elevated temperatures can allow a peroxide to decompose and form a highly reactive radical, which can initiate free-radical polymerization. In some examples, decomposed peroxides and their derivatives can be byproducts.

The free-radical photoinitiator can be a single free-radical photoinitiator or a mixture comprising two or more different free-radical photoinitiators. The concentration of the free-radical photoinitiator can be from 0.1 to 6% (w/w), alternatively from 1 to 3% (w/w), based on the weight of the silicon compounds in the free-radical curable silicone composition.

In amine-epoxy curing, for example, a primary- or secondary-amine reacts with an epoxy compound to produce, for example, aminoalcohols, The epoxy-containing compound can be an organosilicon compound, or an organic compound that does not include silicon. The primary- or secondary-amine-containing compound can be an organosilicon, or an organic compound that does not include silicon. An amine-functional compound can be an amine-functionalized organopolysiloxane.

In an example, an amine-epoxy curable composition includes an epoxy-functional organosilicon compound and an amino-functional curing agent. In one example, the epoxy-functional organosilicon compound is a polysiloxane compound. The epoxy-functional organosilicon compound can have an average or at least two silicon-bonded epoxy-substituted functional groups per molecule and the curing agent can have an average of at least two nitrogen-bonded hydrogen atoms per molecule.

Radiation that can be used for radiation curing includes, for example, visible light, infrared light, microwaves, radio waves, very low frequency waves, extremely low frequency waves, thermal radiation (heat), and black-body radiation. Any of the curing methods disclosed herein can include radiation curing; for example, any of the curing methods disclosed herein can include the application of heat or light. For example, any of a hydrosilylation curable composition, a condensation curable composition, an epoxy-amine curable composition, or a composition curable by cooling, a free-radical curable composition, can include one or more steps that include the application of radiation, and the application of radiation to the curable composition can initiate, assist, or cause the chemical or physical processes that are part of the curing process. In some embodiments, any of hydrosilylation curing, condensation curing, epoxy-amine curing, free-radical curing, or curing via cooling can also be described as radiation curing, due to the application of radiation during the curing process. In other embodiments, any of hydrosilylation curing, condensation curing, epoxy-amine curing, free-radical curing, or curing via cooling are not described as radiation curing, due to the lack of applied radiation during the curing process.

In one example of cooling giving a cured product of a silicone composition, an organosilicone composition that essentially has a liquid flowable state is cooled at least as low as room temperature to give a silicone composition that essentially has a solid nonflowable state. Silicone compositions that include compounds that can behave as thermoplastics are an example of silicon composition that can be cooled to give a cured product of the silicon composition. The compound that behaves as a thermoplastic can be a polymer.

One example of a composition that includes a platinum catalyst is Karstedt's catalyst. One example of a free-radical initiator, which can operate thermally or with light activation, is VAROX DCBP-50 which includes bis(2,4-dichlorobenzoyl) peroxide, 50% in silicone oil.

### Optional Ingredients

Any optional ingredient described herein can be present in the membrane or in the composition that forms the membrane; alternatively, any optional ingredient described herein can be absent from the membrane or the composition that forms the membrane. Without limitation, examples of such optional additional components include surfactants, emulsifiers, dispersants, polymeric stabilizers, crosslinking agents, combinations of polymers, crosslinking agents, catalysts useful for providing a secondary polymerization or crosslinking of particles, rheology modifiers, density modifiers, aziridine stabilizers, cure modifiers such as hydroquinone and hindered amines, free-radical initiators, polymers, diluents, acid acceptors, antioxidants, heat stabilizers, flame retardants, scavenging agents, silylating agents, foam stabilizers, solvents, diluents, plasticizers, fillers and inorganic particles, pigments, dyes and dessicants. Liquids can optionally be used. An example of a liquid includes water, an organic solvent, any liquid organic compound, a silicone liquid, organic oils, ionic fluids, and supercritical fluids. Other optional ingredients include polyethers having at least one alkenyl group per molecule, thickening agents, fillers and inorganic particles, stabilizing agents, waxes or wax-like materials, silicones, organofunctional siloxanes, alkylmethylsiloxanes, siloxane resins, silicone gums, silicone carbinol fluids can be optional components, water soluble or water dispersible silicone polyether compositions, silicone rubber, hydrosilylation catalyst inhibitors, adhesion promoters, heat stabilizers, UV stabilizers, and flow control additives.

The present invention can be better understood by reference to the following examples which are offered by way of illustration. The present invention is not limited to the examples given herein.

General Method for non-hypothetical examples. A feed gas comprising dry compressed air at 120 standard cubic feet per hour (scfh) and ambient temperature (approximately 22° C.) was moistened to a specified relative humidity (RH) and used to dry 600 g samples of yellow dent corn in a lab scale corn bin. The RH values were measured using digital relative humidity sensors (Omega). The corn was a yellow dent hybrid (Pioneer Brand P1184HR, planted on May 13, 2011 in Morocco, Indiana and combine harvested on Nov. 1, 2011 at 16.3% wet basis moisture content, then artificially re-wet to approximately 22% wet basis moisture content by exposing to a humidifier). The RH was controlled by varying the ratio of air entering a water bubbler to air bypassing said bubbler and combining both streams. The resultant air stream was fed into the bottom of a custom-built laboratory-scale corn dryer (8″ diameter, 9″ height), which was designed to mimic a corn-drying bin, The corn sample was supported on a perforated mesh floor, under which the air was fed and allowed to sweep upward through a vented roof. Corn moisture content was measured with a Dickey-John Mini GAC1 grain moisture meter after various periods of drying and recorded. The experiments were conducted under ambient laboratory temperature.

### AMBIENT DRYING OF GRAIN, EXAMPLES 1-3

### Example 1

Air was moistened to 17% relative humidity (RH) and used to dry a 600 g sample of yellow dent corn according to the General Method. Table 1 contains corn moisture content on a wet basis, M_{W}, as determined experimentally at various times.

TABLE 1
Experimental corn moisture
content dried with 17% RH air.

| Time, hours | Experimental M_{W}, % |
|---|---|
| 0 | 22.2 |
| 1 | 20.8 |
| 2 | 19.5 |
| 3.5 | 17.9 |
| 5 | 17.3 |
| 7 | 16.6 |
| 24 | 12.9 |

### Example 2

Air was moistened to 34% RH and used to dry a 600 g sample of yellow dent corn according to the General Method. Table 2 contains corn moisture content on a wet basis, M_{W}, as determined experimentally at various times.

TABLE 2
Experimental corn moisture
content dried with 34% RH air.

| Time, hours | Experimental M_{W}, % |
|---|---|
| 0 | 23.1 |
| 1 | 21.8 |
| 2 | 20.9 |
| 3.5 | 19.0 |
| 5 | 18.5 |
| 6 | 18.0 |
| 8 | 16.9 |
| 9 | 16.2 |

### Example 3

Air was moistened to 53% RH and used to dry a 600 g sample of yellow dent corn according to the General Method. Table 3 contains corn moisture content on a wet basis, M_{W}, as determined experimentally at various times.

TABLE 3
Experimental corn moisture
content dried with 53% RH air.

| Time, hours | Experimental M_{W}, % |
|---|---|
| 0 | 23.0 |
| 1 | 22.9 |
| 2 | 21.6 |
| 3.5 | 20.3 |
| 5 | 19.2 |
| 6 | 19.0 |
| 8 | 18.0 |

Examples 1-3 provide evidence that reducing the RH of the air results in faster drying of grains at ambient conditions.

### Example 4

### Grain Drying with a Silicone Hollow Fiber Membrane Module

100 scfh of moistened air was dried by passing through a 0.83 m² silicone hollow fiber membrane module (MedArray, Inc, Permselect module). The dry air stream was first moistened by passing through a water bubbler, and the wet bubbler effluent was fed lumen-side to the membrane. A vacuum of approximately 200 Torr was applied on the permeate side of the membrane. The retentate air was used to dry the corn sample using the laboratory scale corn drying bin, as described in the General Method. The RH of the feed and retentate streams to/from the membrane module was monitored. Corn moisture content was measured with a grain moisture meter after various periods of drying, The experiment was conducted under ambient laboratory temperature (approximately 22 ° C.).

Table 4 contains feed RH, retentate RH, and experimental corn moisture content, M_{W}, at various times.

TABLE 4
Membrane feed RH, retentate RH, and corn moisture content.

| Time, hours | Feed RH, % | Retentate RH, % | M_{W}, % |
|---|---|---|---|
| 0 | — | — | 21.2 |
| 1 | 80.4 | 40.9 | 19.5 |
| 2 | 66.5 | 27.8 | 18.2 |
| 3.5 | 64.4 | 34.2 | 17.4 |
| 5 | 62.0 | 31.6 | 16.6 |
| 6.5 | 61.4 | 32.3 | 16.3 |
| 8 | 61.0 | 36.6 | 15.5 |

### Comparative Example 1

The experiment was conducted identically as in Example 4, except the membrane was removed from the apparatus, and the bubbler effluent was fed directly to the corn-drying bin. Table 5 contains air RH and experimental corn moisture content, M_{W}, at various times.

TABLE 5
Air RH and corn moisture content.

| Time, hours | Air RH, % | M_{W}, % |
|---|---|---|
| 0 | — | 21.7 |
| 1 | 59.2 | 21.3 |
| 2 | 56.1 | 20.7 |
| 3 | 58.2 | 19.6 |
| 4 | 55.6 | 19.2 |
| 5 | 55.0 | 18.5 |
| 6 | 54.6 | 18.0 |
| 7 | 54.1 | 17.4 |

Example 4 and Comparative Example 1 provide evidence that membrane-dried air offers significantly faster drying of grains than using untreated air under identical air temperatures.

### Hypothetical Examples

In the drying estimations below, the time needed to achieve a certain moisture content in corn is obtained from the thin layer drying equation

(“Equation 1”):

Moisture ratio=MR=((M-Mₑ)/(Mᵢ-Mₑ))=exp(-k*tⁿ),

wherein k for corn=exp(-7.1735+1.2793*In T+0.137*v), for 2.2≦T≦71.1, and n=0.811*In(rh)+0.78*Mᵢ for 3≦rh≦83, where M=instantaneous moisture content, decimal dry basis, Mₑ=equilibrium moisture content, decimal dry basis, Mᵢ=initial moisture content, decimal dry basis, T=temperature in °C., rh =relative humidity (from Misra, M. K. and Brooker, D. B., 1980, Transactions of the ASAE 23(5):1254-1260. Thin layer drying and rewetting equations for shelled yellow corn.) Equilibrium moisture content, Mₑ, is obtained from well-known tables in the literature that correlate equilibrium moisture content of corn at various temperatures and relative humidities.

A variety of methods can be used to measure the permeability of a membrane to particular gases. In one example, gas permeability coefficients and ideal selectivities in a binary gas mixture can be measured using a permeation cell including upstream (feed/retentate) and downstream (permeate) chambers that are separated by the membrane. The upstream chamber has one gas inlet and one gas outlet. The downstream chamber has one gas outlet. The upstream chamber is maintained at 35 psig pressure and is continuously supplied with a suitable mixture of H₂O vapor and N₂ gas at a flow rate of between 0-200 standard cubic centimeters per minute (sccm). Under equilibrium conditions at a specified temperature and pressure, a specific amount of H₂O vapor is formed in a bubbler device by introducing N₂ gas at a flow rate of between 0-200 sccm. The bubbler is filled with H₂O liquid and is temperature controlled. The relative humidity of the bubbler outlet can be controlled to a desired level by adjusting the bubbler temperature, pressure, and/or N₂ gas flow rate. The relative humidity of the bubbler outlet may be controlled further by combination with a dry stream of N₂ gas. A relative humidity sensor is located between the bubbler outlet and the upstream chamber. The membrane is supported on a glass fiber filter disk with a diameter of 83 mm and a maximum pore diameter range of 10-20 μm (Ace Glass). The membrane area is defined by a placing a butyl rubber gasket with a diameter of 50 mm (Exotic Automatic & Supply) on top of the membrane. The downstream chamber is maintained at 5 psig pressure and is continuously supplied with a pure He stream at a flow rate of 20 sccm. To analyze the permeability and selectivity of the membrane, the outlet of the downstream chamber is connected to a 6-port injector equipped with a 1-mL injection loop and a relative humidity sensor. On command, the 6-port injector injects a 1-mL sample into a gas chromatograph (GC) equipped with a thermal conductivity detector (TCD). The amount of gas permeated through the membrane is calculated by calibrating the response of the TCD detector to the gases of interest. The reported values of gas permeability and selectivity are obtained from measurements taken after the system has reached a steady state in which the permeate side gas composition becomes invariant with time. The upstream and downstream chamber H₂O vapor mole fractions are calculated from the respective relative humidity sensor data. These mole fractions may also be used to calculate H₂O vapor permeability. Experiments are run at temperatures above the H₂O vapor dew point to prevent condensation or at a suitably elevated temperature to simulate operating conditions. All lines downstream of the bubbler outlet are insulated and/or temperature controlled to prevent H₂O vapor condensation.

### Hypothetical Comparative Example 2

Atypical drying of corn that is harvested at about 20 wt % moisture content (wet basis) and dried to about 15% moisture content (wet basis) to be market-ready is estimated using drying time models (See, Tables 6-8) to require about 51.2 days by drying time estimates of Equation 1at 20 ° C. and 60% relative humidity (RH) using a fan with linear air velocity of about 0.11 m/s (assuming 15,000 scfm volumetric flow blowing across or through a 9.1 m (approximately 30 foot) diameter storage bin).

### Hypothetical Comparative Example 2

A typical drying of corn that is harvested at about 20 wt % moisture content (wet basis) and dried to about 15% moisture content (wet basis) to be market-ready is estimated using drying time models (See, Tables 6-8) to require about 5.3 days by drying time estimates of Equation 1 at 38° C. and 60% relative humidity (RH) using a fan with linear air velocity of about 0.11 m/s (assuming 15,000 scfm volumetric flow blowing across or through a9.1 m (approximately 30 foot) diameter storage bin), The air is assumed to be heated to 38° C. using an energy source such as fuel or electricity.

### Hypothetical Comparative Example 3

A typical dehumidification of moist outdoor air for heating, ventilation, and air conditioning applications requires cooling of the moist outdoor air beyond the dewpoint to condense water vapor, thereby removing water, followed by heating to adjust temperature and relative humidity to ensure comfortable working or living conditions for occupants inside a building or structure. It is estimated that about 75 MJ/min must be removed from a moist air feed stream of 46,000 ft³/min, at 30° C., 1.2 atm, and 85% RH to produce saturated air at about 13° C. and 1 atm using a heat exchanger or form of cooling operation. The saturated air is then heated before entering a budding or structure to control the indoor temperature and to reduce relative humidity to comfortable levels.

### Hypothetical Example 1

A silicone hollow fiber membrane system was designed to dry the ambient air at 20° C. and 60% RH down to 30% RH using ASPEN/HYSYS process simulation software (Membrane Unit Extension v3.0a). The one or more membranes, a hydrosilylation cured polydimethylsiloxane silicone hollow fiber membrane module having permeance values of (PII)_{H20}1150 gas permeation units (GPU) where 1 GPU=10⁻⁶ cm³(STP)/(cm²*s*cm Hg), (PII)_{O2}=20 GPU, and (PII)N2=10 GPU, were fed 15,000 SCFM air at 2 atm and 20° C. at a relative humidity of 60%. To dry this feed to a retentate stream of 14,875 SCFM dry air at 1.8 atm (0.8% stage cut), 20° C. and 30% RH, and yield a permeate flow of 125 SCFM at 1.0 atm and 20° C., the ASPEN/HYSYS model requires a total surface area of 2130 m². This hollow fiber membrane module was configured with a compressor and pre-filter to remove dust and particulates, and the retentate stream was used to supply the air intake to the same storage bin of Hypothetical Comparative Example 1. The drying time model of Equation 1 indicates that by dehumidifying the air by passing the moist ambient air through the silicone hollow fiber membrane system having the approximately 2200 m² of area operating with a transmembrane pressure drop of about 1 atm, the retentate stream can be dried to about 30% RH with sufficient flow rate to feed the blower to the 30 foot diameter storage bin to reduce the drying time to under about 20 days (about 2.6 times faster than Hypothetical Comparative Example 1).

TABLE 6
Corn.

| | |
|---|---|
| Initial moisture content, wet basis, Mᵢw (%) | 20 |
| Initial moisture content, dry basis, Mᵢd (decimal) | 0.25 |
| Desired moisture content, dry basis, Mw (%) | 15 |
| Desired moisture content, dry basis, Md (decimal) | 0.176 |

TABLE 7
Case 1. Natural Air Drying.

| | |
|---|---|
| Outdoor temp (° F.) | 68 |
| Ambient RH (%) | 60 |
| Equilibrium moisture content, wet basis (Mₑw)(%) | 13.5 |
| Equilibrium moisture content, dry basis (Mₑd) | 0.156 |
| (decimal) | |
| Fan flow capacity (scfm) | 15000 |
| Bin diameter (ft) | 30 |
| Air velocity (m/s) | 0.108 |
| Drying equation: moisture ratio, MR | 0.217 |
| Drying equation: k (exponential factor) | 0.036 |
| Drying equation: n (exponent) | 0.527 |
| Time (hours) | 1229 |
| Time (days) | 51 |

TABLE 8
Case 2. Dried Air Drying.

| | |
|---|---|
| Outdoor temp (° F.) | 68 |
| Pre-dried air RH (%) | 30 |
| Equilibrium moisture content, wet basis (Mₑw) (%) | 8.8 |
| Equilibrium moisture content, dry basis (Mₑd) | 0.096 |
| (decimal) | |
| Fan flow capacity (scfm) | 15000 |
| Bin diameter (ft) | 30 |
| Air velocity (m/s) | 0.108 |
| Drying equation: moisture ratio, MR | 0.521 |
| Drying equation: k (exponential factor) | 0.036 |
| Drying equation: n (exponent) | 0.471 |
| Time (hours) | 472 |
| Time (days) | 19 |

### Hypothetical Example 2

A silicone hollow fiber membrane system was designed to dry the ambient air at 20° C. and 60% RH down to 40% RH using ASPEN/HYSYS process simulation software (Membrane Unit Extension v3.0a). The one or more membranes, a hydrosilylation cured polydimethylsiloxane silicone hollow fiber membrane module having permeance values of (PII)_{H20}1150 GPU, (PII)_{O2}=20 GPU, and (PII)_{N2}=10 GPU, were fed 15,000 SCFM air at 2 atm and 20° C. at a relative humidity of 60%. To dry this feed to a retentate stream of 14,930 SCFM dry air at 1.8 atm (0.5% stage cut), 20° C. and 40% RH, and yield a permeate flow of 70 SCFM at 1.0 atm and 20° C., the ASPEN/HYSYS model requires a total surface area of 1150 m². This hollow fiber membrane module was configured with a compressor and pre-filter to remove dust and particulates, and the retentate stream was used to supply the air intake to the same storage bin of Hypothetical Comparative Example 1. The drying time model of Equation 1 indicates that by dehumidifying the air by passing the moist ambient air through the silicone hollow fiber membrane system having the approximately 1200 m² of area operating with a transmembrane pressure drop of about 1 atm, the retentate stream can be dried to about 40% RH with sufficient flow rate to feed the blower to the 30 foot diameter storage bin to reduce the drying time to about 22 days (about 2.3 times faster than Hypothetical Comparative Example 1).

### HYPOTHETICAL EXAMPLE 3

A silicone hollow fiber membrane system was designed to dry the ambient air at 20° C. and 60% RH down to 50% RH using ASPEN/HYSYS process simulation software (Membrane Unit Extension v3.0a). The one or more membranes, a hydrosilylation cured polydimethylsiloxane silicone hollow fiber membrane module having permeance values of (PII)_{H20}=1150 GPU, (PII)_{O2}=20 GPU, and (PII)_{N2}=10 GPU, were fed 15,000 SCFM air at 2 atm and 20° C. at a relative humidity of 60%. To dry this feed to a retentate stream of 14,970 SCFM dry air at 1.8 atm (0.2% stage cut), 20° C. and 50% RH, and yield a permeate flow of 30 SCFM at 1.0 atm and 20° C., the ASPEN/HYSYS model requires a total surface area of 310 m². This hollow fiber membrane module was configured with a compressor and pre-filter to remove dust and particulates, and the retentate stream was used to supply the air intake to the same storage bin of Hypothetical Comparative Example 1. The drying time model of Equation 1 indicates that by dehumidifying the air by passing the moist ambient air through the silicone hollow fiber membrane system having the approximately 300 m² of area operating with a transmembrane pressure drop of about 1 atm, the retentate stream can be dried to about 50% RH with sufficient flow rate to feed the blower to the 30 foot diameter storage bin to reduce the drying time to about 29 days (about 1,8 times faster than Hypothetical Comparative Example 1).

### Hypothetical Example 4

A silicone hollow fiber membrane system was designed to dry the ambient air at 38° C. and 60% RH down to 30% RH using ASPEN/HYSYS process simulation software (Membrane Unit Extension v3.0a). The one or more membranes, a hydrosilylation cured polydimethylsiloxane silicone hollow fiber membrane module having permeance values of (PII)_{H20}=1150 GPU, (PII)_{O2}=20 GPU, and (PII)_{N2}=10 GPU, were fed 15,000 SCFM air at 2 atm and 38° C. at a relative humidity of 60%. To dry this feed to a retentate stream of 14,777 SCFM dry air at 1.8 atm (1.5% stage cut), 38° C. and 30% RH, and yield a permeate flow of 223 SCFM at 1.0 atm and 38° C., the ASPEN/HYSYS model requires a total surface area of 2330 m². This hollow fiber membrane module was configured with a compressor and pre-filter to remove dust and particulates, and the retentate stream was used to supply the air intake to the same storage bin of Hypothetical Comparative Example 2. The drying time model of Equation 1 indicates that by dehumidifying the air by passing the moist ambient air through the silicone hollow fiber membrane system having approximately 2400 m² of area operating with a transmembrane pressure drop of about 1 atm, the retentate stream can be dried to about 30% RH with sufficient flow rate to feed the blower to the 30 foot diameter storage bin to reduce the drying time to about 2.8 days (about 1.9 times faster than Hypothetical Comparative Example 2).

### Hypothetical Example 5

A silicone hollow fiber membrane system was designed to dry the ambient air at 38° C. and 60% RH down to 40% RH using ASPEN/HYSYS process simulation software (Membrane Unit Extension v3.0a). The one or more membranes, a hydrosilylation cured polydimethylsiloxane silicone hollow fiber membrane module having permeance values of (PII)_{H20}=1150 GPU, (PII)_{O2}=20 GPU, and (PII)_{N2}=10 GPU, were fed 15,000 SCFM air at 2 atm and 38° C. at a relative humidity of 60%. To dry this feed to a retentate stream of 14,875 SCFM dry air at 1.8 atm (0.8% stage cut), 38° C. and 40% RH, and yield a permeate flow of 125 SCFM at 1.0 atm and 38° C., the ASPEN/HYSYS model requires a total surface area of 1210 m². This hollow fiber membrane module was configured with a compressor and pre-filter to remove dust and particulates, and the retentate stream was used to supply the air intake to the same storage bin of Hypothetical Comparative Example 2. The drying time model of Equation 1 indicates that by dehumidifying the air by passing the moist ambient air through the silicone hollow fiber membrane system having the approximately 1200 m² of area operating with a transmembrane pressure drop of about 1 atm, the retentate stream can be dried to about 40% RH with sufficient flow rate to feed the blower to the 30 foot diameter storage bin to reduce the drying time to about 3.1 days (about 1.7 times faster than Hypothetical Comparative Example 2).

### Hypothetical Example 6

A silicone hollow fiber membrane system was designed to dry the ambient air at 38° C. and 60% RH down to 50% RH using ASPEN/HYSYS process simulation software (Membrane Unit Extension v3.0a). The one or more membranes, a hydrosilylation cured polydimethylsiloxane silicone hollow fiber membrane module having permeance values of (PII)_{H20}=1150 GPU, (PII)_{O2}=20 GPU, and (PII)_{N2}=10 GPU, were fed 15,000 SCFM air at 2 atm and 38° C. at a relative humidity of 60%. To dry this feed to a retentate stream of 14,958 SCFM dry air at 1.8 atm (0.3% stage cut), 38° C. and 50% RH, and yield a permeate flow of 42 SCFM at 1.0 atm and 38° C., the ASPEN/HYSYS model requires a total surface area of 320 m². This hollow fiber membrane module was configured with a compressor and pre-filter to remove dust and particulates, and the retentate stream was used to supply the air intake to the same storage bin of Hypothetical Comparative Example 2. The drying time model of Equation 1 indicates that by dehumidifying the air by passing the moist ambient air through the silicone hollow fiber membrane system having the approximately 300 m² of area operating with a transmembrane pressure drop of about 1 atm, the retentate stream can be dried to about 50% RH with sufficient flow rate to feed the blower to the 30 foot diameter storage bin to reduce the drying time to about 3.8 days (about 1.4 times faster than Hypothetical Comparative Example 2).

### Hypothetical Example 7

A silicone hollow fiber membrane system was designed to dry moist outdoor air at 30° C. and 85% RH down to 50% RH using ASPEN/HYSYS process simulation software (Membrane Unit Extension v3.0a), The one or more membranes, a hydrosilylation cured polydimethylsiloxane silicone hollow fiber membrane module having permeance values of (PII)_{H20}=1150 GPU, (PII)_{O2}=20 GPU, and (PII)_{N2}=10 GPU, were fed 46,000 SCFM air at 1.2 atm and 30° C. at a relative humidity of 85%. To dry this feed to a retentate stream of 45,080 SCFM dry air at 1 atm (2% stage cut), 30° C. and 50% RH, and yield a permeate flow of 920 SCFM at 0.2 atm and 30° C., the ASPEN/HYSYS model requires a total surface area of 11,200 m². This hollow fiber membrane module was configured with a fan and pre-filter to remove dust and particulates, a vacuum on the permeate side, and the retentate stream was used to supply the air intake to the same heat exchanger or cooling operation in Comparative Example 3. The same calculations used in Comparative Example 3 indicate that by dehumidifying the air by passing the moist outdoor air through the silicone hollow fiber membrane system having the approximately 11,000 m² of area operating with a transmembrane pressure drop of about 1 atm, the retentate stream can be dried to about 50% RH and reduce the amount of energy needed to be removed to produce saturated air at about 13° C. and 1 atm to 41 MJ/min (about 1.8 less energy than Comparative Example 3).

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method of drying a feed gas mixture, the method comprising:
contacting a first side of one or more membranes with a feed gas mixture comprising at least water and a second gas component to produce a permeate gas mixture on a second side of the one or more membranes and a retentate gas mixture on the first side of the one or more membranes,
wherein the permeate gas mixture is enriched in water, and the retentate gas mixture is depleted in water,
wherein the one or more membranes have an H₂O vapor permeability coefficient of at least about 25,000 Barrer at room temperature.

2. A method of drying a material, comprising the method of claim 1, further comprising contacting a material with the retentate gas mixture, to provide a dried material.

3. The method of claim 1, wherein the second gas component is ambient air.

4. The method of claim 1, wherein the retentate gas mixture has a lower concentration of water than the feed gas mixture.

5. The method of claim 2, wherein the material comprises at least one of crops, grains, foodstuffs, coal, particles, powders, tobacco, wood, lumber, chemicals, sand, plaster, wastewater sludge, paint, coatings, varnishes, inks, produce, meats, gas, textiles, clothing, and furniture.

6. The method of claim 1, wherein the one or more membranes comprise a polysiloxane.

7. The method of claim 1, wherein the one or more membranes comprise a cured product of an organo silicon composition, wherein the curing comprises hydrosilylation curing, condensation curing, free-radical curing, epoxy-amine curing, radiation curing, evaporative curing, or cooling.

8. The method of claim 1, wherein the one or more membranes have a thickness of from about 0.1 to about 200 ₗμm.

9. The method of claim 1, wherein the one or more membranes are independently selected from a plate membrane, a spiral wound membrane, tubular membrane, and hollow fiber membrane.

10. The method of claim 1, wherein any one or more of the one or more membranes independently comprise an unsupported membrane.

11. The method of claim 1, wherein any one or more of the one or more membranes independently comprise a free-standing hollow fiber.

12. The method of claim 1, wherein any one or more of the one or more membranes independently further comprise one or more substrates, wherein the any one or more of the one or more substrates are porous substrates or non-porous highly permeable substrates, wherein the any one or more of the one or more membranes comprise supported membranes.

13. The method of claim 1, further comprising pressurizing the feed stream or reducing the pressure of the feed stream.

14. The method of claim 1, further comprising treating the feed stream with at least one pre-filter to remove particulates.

15. The method of claim 1, further comprising purging the permeate stream with a sweep gas.

16. The method of claim 1, further comprising using the retentate gas mixture for air conditioning or refrigeration.

17. A method of drying corn, grain, or foodstuffs, the method comprising:
contacting a first side of one or more membranes with a feed gas mixture comprising at least water and air to produce a permeate gas mixture on a second side of the one or more membranes and a retentate gas mixture on the first side of the one or more membranes,
wherein the permeate gas mixture is enriched in water, and the retentate gas mixture is depleted in water,
wherein the one or more membranes have an H₂O vapor permeability coefficient of at least 25,000 Barrer at room temperature and a total surface area of at least 300 m²; and
contacting corn, grain, or foodstuffs with the retentate gas mixture, to provide a dried corn, dried grain, or dried foodstuffs.

18. The method of claim 12, wherein any one or more of the one or more substrates independently comprises one or more frits comprising a material selected from glass, ceramic, alumina, and a porous polymer.

19. The method of claim 12, wherein any one or more of the one or more substrates independently comprises a plurality of fibers.

20. The method of claim 12, wherein any one or more of the one or more substrates comprises a filter.
